(19) United States
(12) Patent Application Publication
(10) Pub. No.: US 2023/0205930 A1
(43) Pub. Date: Jun. 29, 2023

(54) Enhancing Data Privacy and Owner Capture of Data Value

(71) Applicant: AT&T Intellectual Property I, L.P., Atlanta, GA (US)

(72) Inventors: Ginger Chien, Bellevue, WA (US); Jennifer Joy, Santa Cruz, CA (US); Joan Gingery, San Ramon, CA (US); Norma Berry, Columbia, SC (US)

(73) Assignee: AT&T Intellectual Property I, L.P., Atlanta, GA (US)

(21) Appl. No.: 17/564,714

(22) Filed: Dec. 29, 2021

(51) Int. Cl. G06F 21/62; H04L 9/40; G06Q 20/38; G06Q 10/08

(52) U.S. Cl. CPC G06F 21/6254; H04L 63/0281; G06Q 20/383; G06Q 10/087

(57) ABSTRACT

Concepts and technologies disclosed herein are directed to enhancing data privacy and owner capture of data value. According to one aspect disclosed herein, an obfuscation and orchestration proxy system can receive a request for a service. The request can originate from a user. The user can be associated with user data. The obfuscation and orchestration proxy system can determine a business flow to be used to provide the service. The business flow can identify a disaggregated provider component to provide, at least in part, the service. The obfuscation and orchestration proxy system can provide a portion of the user data to the disaggregated provider component. The obfuscation and orchestration proxy system can reveal a further portion of the user data to the disaggregated provider component. The obfuscation and orchestration proxy system can obfuscate the portion of the user data for data passthrough to one or more other disaggregate provider components.

### BACKGROUND

Privacy, data harvesting, and unclear or absent compensation are typically exploited by monolithic e-commerce systems. In such systems, users have few opportunities, if any, to manage the privacy of or to decouple the steps involved with an action, such as a shopping purchase during which discovery activities, shipments methods, addresses, and financial information are all revealed in full to a monolithic entity. Discovery and manually interacting with the separate components during an e-commerce experience using search engines in a way that protects user privacy is inconvenient and beyond the technical means of most users. A standard internet proxy solution is inadequate with a monolithic e-commerce service because virtually all data, including a substantially accurate inferred machine identity if not an actual deduced machine identity, is still collected and associated with a rich set of user identity information already stored at the monolithic service under a user profile.

Past solutions to the aforementioned problems have primarily involved using conventional proxies to block the identity of a user's device at the protocol level. However, in a typical e-commerce solution, the user still must provide data that can be harvested and associated by the e-commerce solution at the user level. This makes blocking the machine identification of little value. Some search services are seller-driven and aggregate seller/provider data for free searches; however, these services still do not provide any advantage to the user capturing value in their identity. Presently, no solution decouples all of the information to the greatest possible degree. While monolithic systems will likely retain processing speed and other performance advantages, these may be of little importance to users who value the opportunity to enforce a higher level of privacy over their data and for users who wish to enjoy a competitive environment that captures value from the user's release of certain data.

Another category of existing solution involves browser solutions such as Brave or Gener8, which reward the user with credit or cryptocurrency in return for their engagement time or visibility into activities. However, these solutions still appear to capture and benefit from all private data passing through the browser.

### SUMMARY

Concepts and technologies disclosed herein are directed to enhancing data privacy and owner capture of data value. According to one aspect of the concepts and technologies disclosed herein, an obfuscation and orchestration proxy system can include a processor and a memory. The memory can include instructions that, when executed by the processor, cause the processor to perform operations. In particular, the obfuscation and orchestration proxy system can receive a request for a service. The request can originate from a user. The user can be associated with user data. The obfuscation and orchestration proxy system can determine a business flow to be used to provide the service. The business flow can identify a disaggregated provider component to provide, at least in part, the service. The obfuscation and orchestration proxy system can provide a portion of the user data to the disaggregated provider component.

In some embodiments, the obfuscation and orchestration proxy system can reveal one or more further portions of the user data to the disaggregated provider component. In some embodiments, the obfuscation and orchestration proxy system can obfuscate the portion(s) of the user data for data passthrough to one or more other disaggregated provider components. In some embodiments, the obfuscation and orchestration proxy system can coordinate with the disaggregated provider component to provide one or more further portions of the user data using a temporary transaction-specific key.

In some embodiments, the service is an e-commerce service, the business flow is an e-commerce flow, and the disaggregated provider component is a catalog service component. In these embodiments, the portion of the user data can include an obfuscated user identifier. The request also can identify one or more search terms. The search terms can be associated with the obfuscated user identifier so that the user can benefit from a search history feature when browsing a catalog provided by the catalog service component without the catalog service component knowing the true identity of the user or their search history. The obfuscation and orchestration proxy system can receive, from the catalog service component, a product identifier that identifies a product matching the search term. The obfuscation and orchestration proxy system can provide the product identifier to a supplier. The obfuscation and orchestration proxy system can receive, from the supplier, an offer and supplier identifier associated with the supplier. The obfuscation and orchestration proxy system can provide the offer and the supplier identifier to the user. The obfuscation and orchestration proxy system can receive, from the user, an order specifying a payment method and a shipping destination. The obfuscation and orchestration proxy system can provide the order to the supplier and can receive a digital claim ticket for the order. The obfuscation and orchestration proxy system can then provide the digital claim ticket to the user. The obfuscation and orchestration proxy system can obfuscate any data exchanged in the aforementioned transaction. For example, the obfuscation and orchestration proxy system can obfuscate the product identifier, the supplier identifier, the payment method, the shipping destination, or a combination thereof.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment for various concepts and technologies disclosed herein.

FIG. 2 is a flow diagram illustrating aspects of a method for enhancing data privacy via an obfuscation and orchestration proxy system, according to an illustrative embodiment of the concepts and technologies disclosed herein.

FIG. 3 is a flow diagram illustrating aspects of an e-commerce flow, according to an illustrative embodiment of the concepts and technologies disclosed herein.

FIG. 4 is a flow diagram illustrating aspects of a monetary optimization flow, according to an illustrative embodiment of the concepts and technologies disclosed herein.

FIG. 5 is a block diagram illustrating an example computer system capable of implementing aspects of the concepts and technologies disclosed herein.

FIG. 6 is a block diagram illustrating an example mobile device capable of implementing aspects of the concepts and technologies disclosed herein.

FIG. 7 is a block diagram illustrating an example network capable of implementing aspects of the concepts and technologies disclosed herein.

FIG. 8 is a block diagram illustrating a virtualized cloud architecture capable of implementing aspects of the concepts and technologies disclosed herein.

FIG. 9 is a block diagram illustrating a machine learning system capable of implementing aspects of the concept and technologies disclosed herein.

### DETAILED DESCRIPTION

Currently, a solution does not exist that allows for minimally necessary, fragmentary data to be exposed to separate and independently operated components of an e-commerce system in a way that still delivers a seamless transaction experience and allows for selective user-driven trading of their data. Such a new system that fragments data would significantly complicate data harvesting efforts, thus enabling users to begin to monetize and attract market-driven compensation for their data. Users can evaluate the individual privacy commitments of competing suppliers and combine them in a way that meets privacy and functional goals unlike with a monolithic system that holds hostage the ability to use the service in return for typically all of a user's data. Users can withhold data and offer selectively more data to influence compensation. The release of incremental data to discover value can be complex and require added user involvement, but this can be simplified with strict privacy floors producing a shortlist of decision options optimized only on cost within those limits. Alternatively, a smart agent within an obfuscation and orchestration proxy can negotiate on behalf of the user subject to various rulesets.

The disclosed solution takes advantage of distributed coordination technologies that have become more viable as communications become faster. Improved communication speed in general allows distributed architectures to become sufficiently fast, reliable, and functional. This allows for distributed architectures to challenge the performance of monolithic end-to-end systems. Furthermore, the disclosed solution differs from monolithic systems that operate with almost unrestricted knowledge of user data by offering an alternative whereby the user can direct the selective release of data in a privacy and real-time bidding framework in which the value of their personal data can be captured within a competitive environment offering confidence and choices in the recaptured value of their data and how privacy is handled. This distributed model permits new trust and commerce models that leverage the physical separation and distinct ownership of individual nodes in ways that enhance transparency over a monolithic system.

The disclosed solution provides an obfuscation and orchestration proxy that not only can perform the task of obfuscating the user's machine/device identity but also the relationships between various subcomponents of the monolithic system by orchestrating the steps of a transaction and only exposing the necessary data to each subcomponent, thus fragmenting the data across independent entities and making a full reconstruction of user data and profiling difficult or impossible. The separation of components, including the obfuscation and orchestration proxy itself, supports the existence of a competitive ecosystem of multiple obfuscation and orchestration proxies and other component providers that allow a user to choose ala carte components based on reputation, reviews, price, perks, and dynamically mix and match components at will, including to meet the search, payment, and other attributes of an individual transaction. Multiple transactions can be operated in parallel, such as, for example, when the obfuscation and orchestration proxy explores multiple sellers and aggregates coarse results for presentation to the user with additional detail such as a name, billing information, and shipping destination revealed when desired to secure a final price.

The orchestration of communications can follow logical flows that might be implemented in a monolithic system but with the option of a range of existing encryption technologies that fulfill a range of encryption and privacy functions to keep data private. This can include simple encryption to ensure the use of data only by an intended endpoint possessing a priori decryption capabilities, mixed encrypted/unencrypted data to allow an enroute component to perform intermediate processing and pass results along with the remaining encrypted data to an endpoint. Single-use protections, time-limited tokens, blockchain approaches, non-repudiation, and related methods can be applied at any point in the flow as needed. These flows may be complex or difficult for users to configure and manage, but a variety of approaches can be applied to improve usability ranging from agreed and optimized flows arranged between a collection of components offered as a service, canned flows that any party can comply with and interact with other components, and dynamically learned flows that adjust based on user behaviors. This logic is democratized and placed within a competitive framework with the ability to mimic the effectiveness of a monolithic provider to an increasing level of speed and functionality as enabled by improving underlying technologies and coordination strategies.

Encryption technologies ensure privacy of exchanged data, and the use of secure tokens and other access control techniques further obfuscates data by offering only minimally needed data to entities needing to make a decision and releasing complete data from the obfuscation and orchestration proxy upon the entity meeting conditions to employ the token. The disclosed solution allows the decoupling of a monolithic system into its components, with component services provided by competing suppliers chosen by the user to deliver required levels of trust and privacy, and with further obfuscation by means of partial-to-full release of data during communications to maximize privacy (e.g., during discovery of a medical provider's competencies without revealing identity or personal medical information). In this medical example, and in a manner analogous to shopping, the obfuscation and orchestration proxy can broker a number of queries to medical providers who participate in the sharing of rich, structured capabilities data (similar to the closed-garden of an insurance company's approved provider search function based on provider competencies). Age and additional medical details (e.g., for a child) could be shared later as a more secure relationship is established.

The significantly improved control over user information, search patterns, and products/services creates the opportunity for users to barter the value of their data to multiple entities who compete to deliver smooth integration of distributed services, privacy commitments, and monetary or other compensation for the data they are permitted to handle. If simplicity or immediacy is important, the user may forego bartering, though much of the process can be handled invisibly by a suitably configured obfuscation and orchestration proxy acting through user-defined rules to negotiate an outcome that meets user requirements. For example, a fully anonymized buyer can express interest in purchasing a product to be shipped to a residence defined only by a 5 digit zip code. As described herein, this level of privacy could be adhered to with a product still being purchased and successfully delivered to the buyer. However, the buyer can barter their identity, willingness to pay cash/debit, or other information in pursuit of a better offer. These options do not exist in monolithic commerce services today.

Although the disclosed solution focuses on addressing privacy concerns with monolithic e-commerce systems, the disclosed solution can apply to any complex transaction and system that can be broken into components to intentionally fragment user information. The concepts and technologies disclosed herein also can apply to situations in which partial information reveals can be managed while searching for data, such as, for example, the competencies of a medical service provider without revealing specific medical details linked to a machine identity, or a user identity, and from which children or other details can be inferred.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

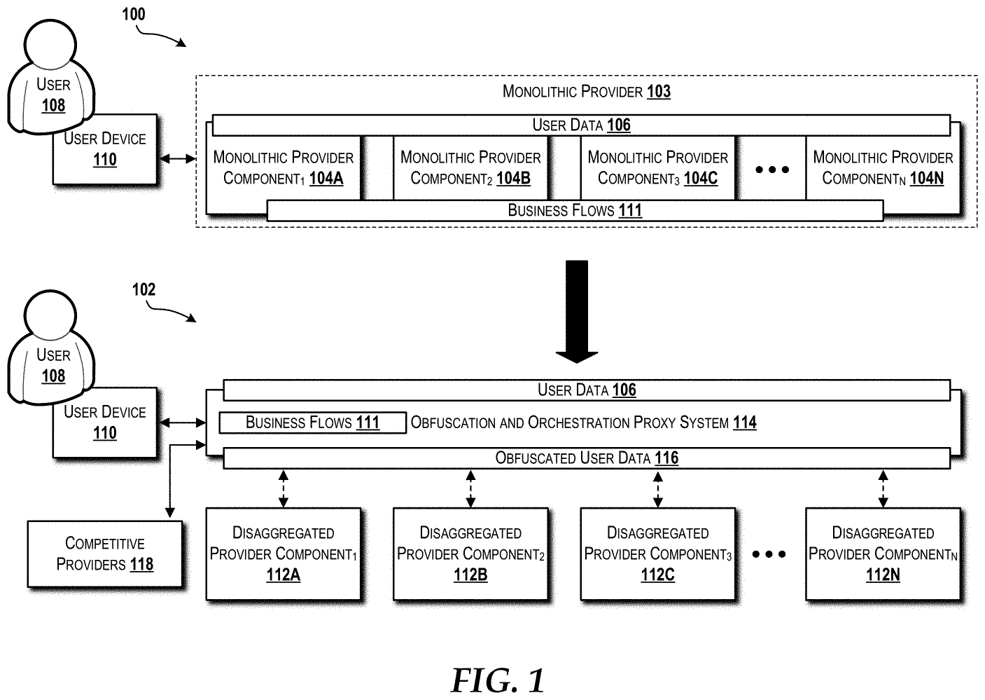

Turning now to FIG. 1, a traditional monolithic solution 100 is shown in comparison to a novel disaggregated provider solution 102, according to an illustrative embodiment of the concepts and technologies disclosed herein. Traditionally, monolithic solutions have enjoyed a period of superior efficiency that eventually peaks when speed/efficiency advantages from avoiding costs such as slow networks become less important as networks and coordination technologies mature. For example, the widely-used concept of real-time web advertisement bidding achieves a previously unimaginably complex real-time user discovery, bid, winner selection, and advertisement delivery/rendering before a user even recognizes that the web page rendering may be taking additional time to load. Monolithic solutions are the most opaque where privacy is concerned because all data is typically captured, the manner of use is unknown other than awareness that appears to flow out to distant service providers through a lucrative user data exchange network, and users have seldom had any competitive options on how their data is applied for user convenience or, by contrast, user exploitation without compensation.

In the illustrated example, a monolithic provider 103 represents a typical, highly-integrated monolithic provider of goods and/or services. The examples provided herein primarily focus on the monolithic provider 103 as an e-commerce provider, but it should be understood that the concepts and technologies disclosed herein are applicable to any type of provider that implements a monolithic design to conduct transactions, handle queries, or exchange data. In the illustrated example, the monolithic provider 103 includes a plurality of monolithic provider components 104A-104N (hereafter referred to individually as “monolithic provider component 104” or collectively as “monolithic provider components 104”). For an e-commerce provider, the monolithic provider components 104 may include a shopping catalog service, a shipping service, and an orchestration service. The orchestration service can ensure that all of the monolithic provider components 104 can share user data 106 as needed to allow a user 108 (or multiple users as the case may be) to search for a product, purchase the product, and have the product delivered to a destination of their choice (typically a home or office). As such, the user data 106 likely contains search terms associated with their search for the product and transaction details, including name, e-mail address, telephone number, payment data (e.g., bank account number, debit card number, or credit card number), billing address, and shipping address. The monolithic provider 103 also may obtain other personal data, such as, for example, date of birth, social security number, answers to various security questions (e.g., “What is your mother's maiden name?”), location, a combination thereof, and/or the like. In some instances, it may be mandatory for the user 108 to supply some or all of this user data 106 in order to complete a transaction. In addition the monolithic provider 103 may collect user data 106 such as IP addresses, login details, application preferences, cookies, other identifiers linked to a user device 110, shopping history, purchase history, user interaction details (e.g., how long a mouse icon hovers, scrolling, clicks, and the like), a combination thereof, and/or the like. In some instances, not all of the user data 106 is needed to complete a transaction, but the monolithic provider 103 still benefits from collecting the user data 106 to enhance certain aspects of their business (e.g., a more personalized shopping experience) and/or monetize the user data 106 outside of the user's 108 control. Often times, the user 108 is obligated to agree to terms and conditions that specify the type of user data 106 that will be collected and a wide range of potential uses for the user data 106. For reasons such as convenience, speed of shipping, and discounts, the user 108 may decide to agree to the terms and conditions and allow the monolithic provider 103 access to the user data 106.

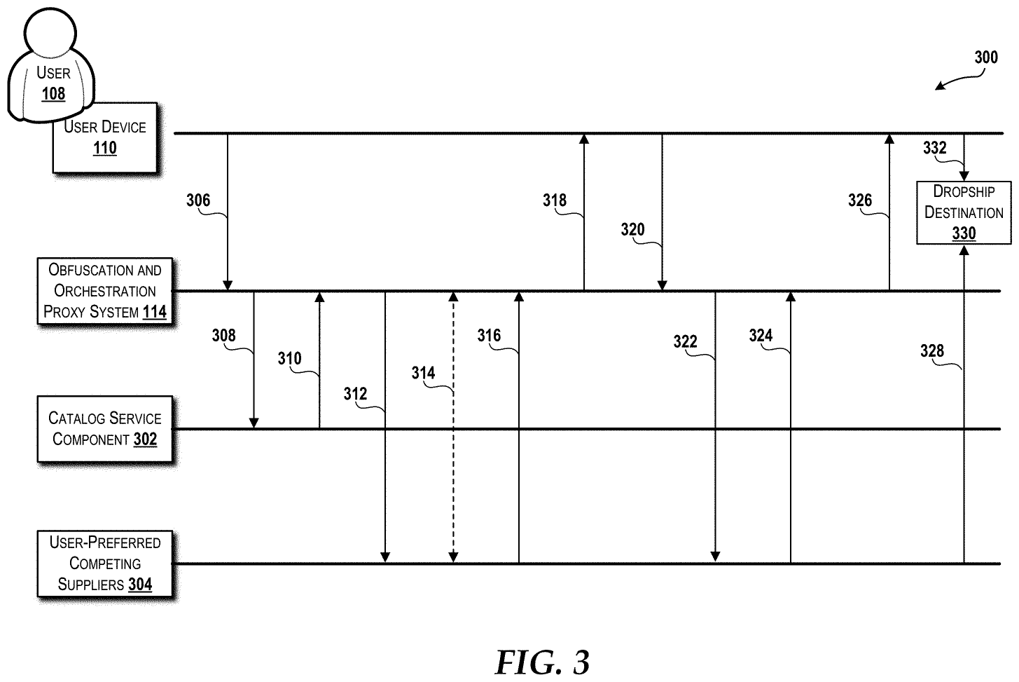

The concepts and technologies disclosed herein introduce the disaggregated provider solution 102 that separates the functional components of the monolithic provider 103 (i.e., the monolithic provider components 104) and any business flows 111 that define how these components communicate. An example of an e-commerce flow will be illustrated and described herein with reference to FIG. 3. As noted above, the concepts and technologies disclosed herein are applicable to other types of business flows. Accordingly, the e-commerce example described herein should not be construed as being limiting in any way. The disaggregated provider solution 102 replaces the monolithic provider components 104 with a minimum of one standalone component to perform each function. In the illustrated example, these standalone components are shown as a plurality of disaggregated provider components 112A-112N (hereafter referred to individually as “disaggregated provider component 112 or collectively as “disaggregated provider components 112”), which may be provided by different providers.

A new and separate platform referred to herein as an obfuscation and orchestration proxy system 114 can execute one or more of the business flows 111 and selectively reveal only the user data 106 to the disaggregated provider components 112 that is needed for initial decision-making. For commitment events that require additional user data 106, the obfuscation and orchestration proxy system 114 can reveal additional user data 106 to the appropriate disaggregated provider component(s) 112. The obfuscation and orchestration proxy system 114 also can obfuscate the user data 106 (shown as “obfuscated user data 116”) when the user data 106 is to be sent through one or more of the disaggregated provider components 112 that do not need the user data 106 and instead act as intermediate node(s) that are enroute to a specific disaggregated provider component 112. The obfuscated user data 116 can be decoded by the disaggregated provider component(s) 112 with a need to know. Moreover, complementary user data 106 that is initially withheld may be retrieved by the disaggregated provider component(s) 112 from the obfuscation and orchestration proxy system 114 using temporary and transaction-specific keys or tokens issued by the obfuscation and orchestration proxy system 114.

The business flows 111 can be pre-determined/canned, custom user-defined, and/or learned over time from interactions with the user 108 and/or other users (not shown). Through the business flows 111, services provided by the disaggregated provider components 112 and the user data 106 are separated with levels of trust expected of each component at the discretion of the user 108. The business flows 111 can be extensible to any complex monolithic system. It should be understood that the more complex the monolithic system is, the more notable the separability of private data from a central party).

For example, a smart home ecosystem such as NEST (available from Google Inc.) could be deconstructed into a separate alarm service, a behavior/energy monitoring service, any compatible third party Internet of Things (“IoT”) devices, and the obfuscation and orchestration proxy system 114 that routes only the necessary user data 106 from relevant devices to relevant services.

The obfuscation and orchestration proxy system 114 and/or each of the disaggregated provider components 112 can be selected by the user 108 from independent competitive providers 118. Other services and/or information sources (not shown) can assemble or recommend solution best-suited to specific use cases. The user 108 may have the option of choosing an obfuscation and orchestration proxy service with the desired business flows 111, preferred relationships with other components (e.g., shopping catalogs, warehouses, shippers, and the like in an e-commerce system), subscription cost (if any), assurances of privacy, allowable levels of repurposing the user data 106, reports on who has requested repurposable user data 106, and the like. Given a description language (e.g., a business process model and notation or more generally a data flow diagram) for business flows 111 in the context of the concepts and technologies disclosed herein, the obfuscation and orchestration proxy system 114 can be upgraded to handle logic outside the typical shop-buy-track-ship model for any transaction involving dependent exchanges of information and/or resources/goods between cooperating elements (e.g., food services, medical services, and the like).

The disaggregated provider components 112 also can be provided in a competitive environment. For example, the user 108 can still shop different catalogs, use different shipping services, and use other related services specifically chosen to meet their needs. The obfuscation and orchestration proxy system 114 can assist in managing preferred disaggregated provider components 112 or automatically choose “best” disaggregated provider component 112 available for use in a given transaction based upon one or more user rules. In some embodiments, the disaggregated provider components 112 may be offered for per-use fee, on a subscription basis, or for free (e.g., seller-supported). It is at the user's 108 discretion whether they want a direct billing relationship with a component provider (which may involve the release of identity and/or financial information).

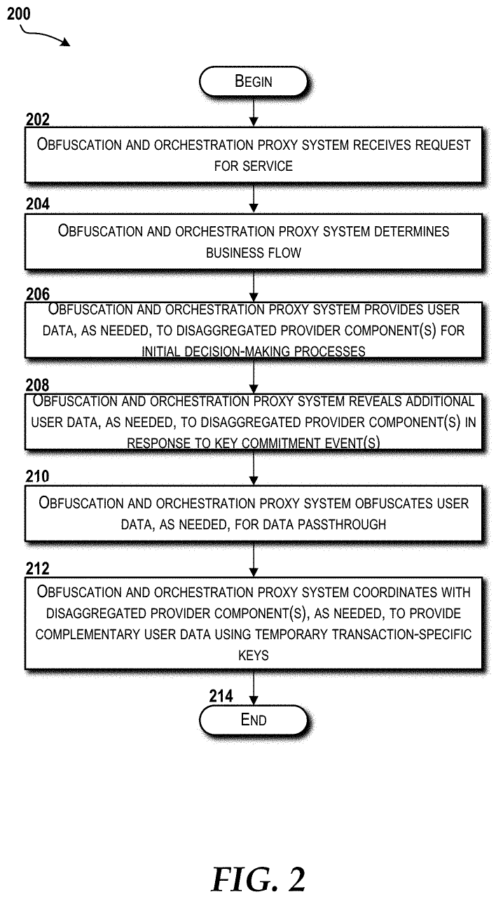

Turning now to FIG. 2, a flow diagram illustrating aspects of a method 200 for enhancing data privacy via the obfuscation and orchestration proxy system 114 will be described, according to an illustrative embodiment. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the obfuscation and orchestration proxy system 114 receives, from the user 108, via the user device 110, a request for services, such as, for example, an e-commerce service. The request can include one or more user requirements that specify the desired business flows 111, preferred relationships with other components (e.g., shopping catalogs, warehouses, shippers, and the like in an e-commerce system), subscription cost (if any), assurances of privacy, allowable levels of repurposing the user data 106, reports on who has requested repurposable user data 106, and the like. In some embodiments, prior to the request, the user 108 can find the obfuscation and orchestration proxy system 114 that best suits their needs (e.g., provides obfuscation and orchestration functions for e-commerce services).

From operation 202, the method 200 proceeds to operation 204. At operation 204, the obfuscation and orchestration proxy system 114 determines the business flow 111 to use to satisfy the request. In particular, the obfuscation and orchestration proxy system 114 can determine the disaggregated provider component(s) 112 that are to be part of the business flow 111 taking into consideration any preferred relationships specified in the request, any costs associated with using specific disaggregated provider component(s) 112, rules to apply to the dissemination of the user data 106 to adhere to any assurances of privacy specified in the request, allowable levels of repurposing the user data 106 specified in the requests, and the like.

From operation 204, the method 200 proceeds to operation 206. At operation 206, the obfuscation and orchestration proxy system 114 provides the user data 106, as needed, to the disaggregated provider component(s) 112 for initial decision-making processes. For example, a catalog service may be able to provide a better service to the user 108 if the catalog service can track a search history for the user 108 based upon a user identifier (e.g., username, real name, email address, IP address, or other user identifier). The user identifier can be obfuscated by the obfuscation and orchestration proxy system 114 and shared with the disaggregated provider component 112 that provides the catalog service.

From operation 206, the method 200 proceeds to operation 208. At operation 208, the obfuscation and orchestration proxy system 114 reveals additional user data 106, as needed to the disaggregated provider component(s) 112 in response to one or more key commitment events. A key commitment event can include any event for which the user 108 must provide additional user data 106 before the business flow 111 can proceed to the next step. Key commitment events for the user 108 to purchase a product might be providing a location, providing a shipping address, and providing financial information. The obfuscation and orchestration proxy system 114 may already have the additional user data 106 and may consult one or more user specified rules (e.g., received as part of the request) to determine whether or not the additional user data 106 can be shared with the disaggregated provider component(s) 112 that have a need to know. The obfuscation and orchestration proxy system 114 may request authorization from the user 108 prior to revealing any additional user data 106. The obfuscation and orchestration proxy system 114 may request the user data 106 from the user 108 as needed to fulfill any key commitment event.

From operation 208, the method 200 proceeds to operation 210. At operation 210, the obfuscation and orchestration proxy system 114 obfuscates the user data 106, as needed for data passthrough. In other words, the obfuscation and orchestration proxy system 114 can obfuscate any user data 106 that will traverse one or more of the disaggregated provider components 112 on a path to a destination disaggregated provider component 112.

From operation 210, the method 200 proceeds to operation 212. At operation 212, the obfuscation and orchestration proxy system 114 coordinates with the disaggregated provider component(s) 112, as needed, to provide complementary user data 106 using temporary transaction-specific keys. As the disaggregated provider component(s) 112 process various requests, the disaggregated provider component(s) 112 might need additional user data 106 that complements the user data 106 already received, in which case the disaggregated provider component(s) 112 can utilize pre-provisioned keys to transact with the obfuscation and orchestration proxy system 114 to obtain such user data 106.

From operation 212, the method 200 proceeds to operation 214. The method 200 can end at operation 214.

Turning now to FIG. 3, an e-commerce flow diagram 300 illustrating a simplified e-commerce transaction example with a few degrees of obfuscation will be described, according to an illustrative embodiment of the concepts and technologies disclosed herein. The e-commerce flow diagram 300 includes the user 108, the user device 110, the obfuscation and orchestration proxy system 114, a catalog service component 302 (e.g., functioning as one of the disaggregated provider components 112), and one or more user-preferred competing suppliers 304 (e.g., functioning as one or more of the disaggregated provider components 112).

An example e-commerce flow begins at operation 306 when the user device 110 provides one or more search terms to the obfuscation and orchestration proxy system 114. The search terms can be directed to the catalog service component 302, which the user 108 may have identified as being a preferred catalog service. Otherwise, the obfuscation and orchestration proxy system 114 can select the catalog service component 302 from potentially multiple catalog services that are available to the user 108. The catalog service component 302 can be a single catalog, an aggregation of multiple catalogs, or even a catalog provided as part of a monolithic service where only the catalog is to be explored by the user 108. The catalog may be chosen in real-time based on the nature of the search to exclude irrelevant catalogs or those who should not be allowed to observe even minimal activity.

To maximize privacy, at operation 308, the obfuscation and orchestration proxy system 114 can obfuscate a user identifier (e.g., as part of the obfuscated user data 116 shown in FIG. 1) to be included with the search terms. In this manner, the catalog service component 302 never knows the identity of the user 108, while the obfuscated user identity permits temporary search history conveniences. The user 108 may choose to release a more static identifier (e.g., an existing username), to accept one or more cookies, and/or otherwise release access to additional user data 116 if features such as, for example, personalized catalog recommendations and/or search history are of value to the user 108. However, the baseline purpose of a standalone catalog, such as provided by the catalog service component 302, is that an anonymous user has browsed certain items.

At operation 310, the catalog service component 302 can respond to the obfuscation and orchestration proxy system 114 with product identifiers (e.g., universal product code “UPC”, stock-keeping unit “SKU”, and the like) and supporting product information (e.g., name, brief description, colors offered, other variations offered, and the like). The UPC/SKU codes could be loaded with tracker codes to track activity as those UPC/SKU codes are used in later operations. For example, a relationship with a catalog service that promises non-trackable product codes or having the obfuscation and orchestration proxy system 114 separately verify the product code as one commonly used by independent catalogs, thus ensuring that there is no transaction-unique embedded data. The user 108 can take the product identifiers and supporting product information to explore pricing from the user-preferred competing suppliers 304. In the illustrated example, at operation 312, the obfuscation and orchestration proxy system 114 can provide a bid request to the user-preferred competing suppliers 304. The bid request can include the product identifiers (obfuscated), an obfuscated user identifier, a location (e.g., obfuscated as a coarse location such as zip code), and any negotiable aspects of the transaction to the user-preferred competing suppliers 304. The bid request may be for a best-and-final price with coarse shipping information or may request further negotiation (shown as operation 314) in exchange for certain user data 106.

At operation 316, the obfuscation and orchestration proxy system 114 can receive offers and associated supplier identification information. At operation 318, the obfuscation and orchestration proxy system 114 can provide the offers and the associated supplier identification information to the user 108. The user 108 can select one of the user-preferred competing suppliers 304 and can place an order (shown as operation 320) for one or more products. The order can specify a selected offer, including the associated supplier identification information, product ID(s), payment method, and shipping address. Payment may be made through an escrow service that anonymizes financial information. The shipping address may be specified as a dropship location to protect the seller and/or shipper from knowing the identity of the user 108. At operation 322, the obfuscation and orchestration proxy system 114 can provide the order information to the user-preferred competing supplier 304 selected by the user 108. In response, at operation 324, the user-preferred competing supplier 304 can provide a digital claim ticket to the obfuscation and orchestration proxy system 114. At operation 326, the obfuscation and orchestration proxy system 114 can provide the digital claim ticket to the user device 110.

At operation 328, the user-preferred competing supplier 304 can ship the product(s) to a shipping address, such as a dropship destination 330 in the illustrated example. At operation 332, the user 108 can travel to the dropship destination 330 and use the digital claim ticket to retrieve the product(s).

Throughout this process is a logically complete relationship between data and the cooperating components. However, the high barrier to extracting and correlating information (possibly against formal privacy policies and commitments that caused the user 108 to select a particular component for use) provides a degree of data protection that does not exist today in monolithic services.

Optimizations can be added to the e-commerce flow described above. The obfuscation and orchestration proxy system 114 may have information on sales, temporarily superior suppliers (e.g., faster shipping times, better prices, and the like) that dynamically changes the set of participating components (i.e., the disaggregated provider components 112) in play. Payment may be optimized for the nature of the product. For example, the obfuscation and orchestration proxy system 114 can choose to reveal a high reward credit card for travel purchases with minimal or no user intervention if the user 108 sets such rules.

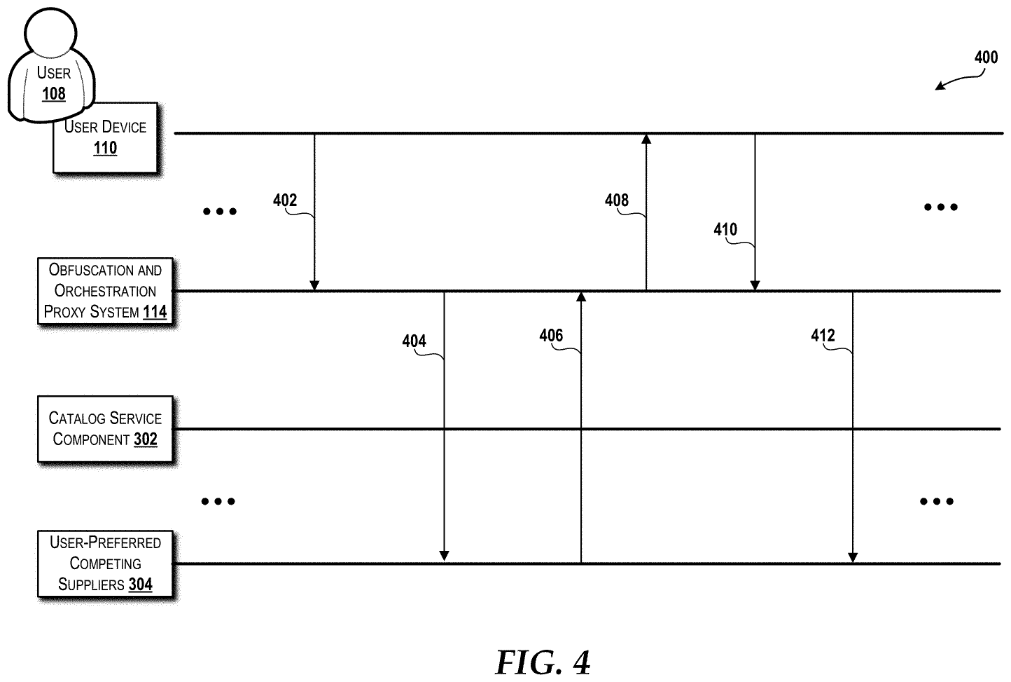

Turning now to FIG. 4, a monetary optimization flow diagram 400 will be described, according to an illustrative embodiment of the concepts and technologies disclosed herein. The monetary optimization flow diagram 400 includes the user 108, the user device 110, the obfuscation and orchestration proxy system 114, the catalog service component 302 (e.g., functioning as one of the disaggregated provider components 112), and the user-preferred competing supplier(s) 304 (e.g., functioning as one or more of the disaggregated provider components 112).

The monetary optimization flow diagram 400 begins at operation 402 when the user 108 requests one or more products via product identifiers and provides a bid request to the obfuscation and orchestration proxy system 114. The bid request can include a set of payment preferences/conditions specified by the user 108. For example, the user 108 may specify that they want the best possible all-inclusive price rather than higher, more flexible itemized prices. The user 108 may also specify acceptable payments methods, which may be profiled depending on product type, seller, and/or other criteria. The user 108 may also specify their willingness to barter (e.g., as barter history or specification) by providing additional user data 106 such as user identifier (real name and/or other contact information) to achieve a better offer. The obfuscation and orchestration proxy system 114 can initially provide an obfuscated user identifier, product identifier(s), the bid request, and any payment conditions to the user-preferred competing suppliers 304 (as shown at operation 404).

At operation 406, the user-preferred competing suppliers 304 can provide offers, including seller-agreed payment details, indication to exercise buyer-offered barter items (e.g., lower price for additional user data 106), and optional services such as product insurance, free shipping upgrades, and the like as compensation for additional user data 106. At operation 408, the obfuscation and orchestration proxy system 114 can forward the offers to the user 108. At operation 410, the user 108 may accept or reject the offers, including partial acceptance or rejection. At operation 412, the obfuscation and orchestration proxy system 114 can obfuscate the user data 106 per the accepted offer and finalize an order to the user-preferred competing supplier 304 associated with the accepted offer.

In some embodiments, the obfuscation and orchestration proxy system 114 can provide payment agent services. For example, the obfuscation and orchestration proxy system 114 can select or recommend a payment method subject to each service provider or itemized products (e.g., default payment method, obfuscated escrow payment service, always use airline credit card for travel, use XYZ credit card for double points this month on food, discount codes, use ready line of credit for major purchases, pay shipping separately with employee discount or credits, and the like). Payment may be delivered in full to one of the disaggregated provider components 112. The payment may then be broken into sub-payments and transferred to subcontractors of a given disaggregated provider component 112 outside of the control of the obfuscation and orchestration proxy system 114. Individual payments may be made by the obfuscation and orchestration proxy system 114. A rich range of payment options may be overlaid on any transaction.

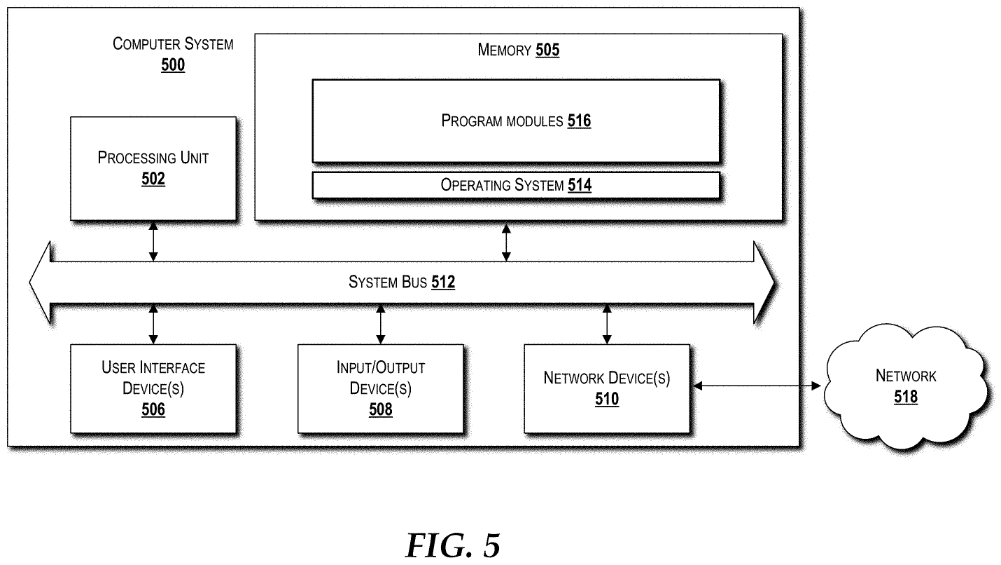

Turning now to FIG. 5, a block diagram illustrating a computer system 500 configured to provide the functionality described herein in accordance with various embodiments. In some embodiments, the user device 110 can be configured the same as or similar to the computer system 500. In some embodiments, the obfuscation and orchestration proxy system 114 can be configured the same as or similar to the computer system 500. In some embodiments, the disaggregated provider component(s) 112 can be configured the same as or similar to the computer system 500.

The computer system 500 includes a processing unit 502, a memory 504, one or more user interface devices 506, one or more input/output (“I/O”) devices 508, and one or more network devices 510, each of which is operatively connected to a system bus 512. The bus 512 enables bi-directional communication between the processing unit 502, the memory 504, the user interface devices 506, the I/O devices 508, and the network devices 510.

The processing unit 502 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 502 can be a single processing unit or a multiple processing unit that includes more than one processing component. Processing units are generally known, and therefore are not described in further detail herein.

The memory 504 communicates with the processing unit 502 via the system bus 512. The memory 504 can include a single memory component or multiple memory components. In some embodiments, the memory 504 is operatively connected to a memory controller (not shown) that enables communication with the processing unit 502 via the system bus 512. The memory 504 includes an operating system 514 and one or more program modules 516. The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, the FREEBSD family of operating systems, the SOLARIS family of operating systems from ORACLE CORPORATION, other operating systems, and the like.

The program modules 516 may include various software and/or program modules described herein. In some embodiments, multiple implementations of the computer system 500 can be used, wherein each implementation is configured to execute one or more of the program modules 516. The program modules 516 and/or other programs can be embodied in computer-readable media containing instructions that, when executed by the processing unit 502, perform the method 200 and/or the flows depicted in FIGS. 3 and 4. According to embodiments, the program modules 516 may be embodied in hardware, software, firmware, or any combination thereof.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media, and therefore should be construed as being directed to “non-transitory” media only.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, or an electronic stylus. Further, the I/O devices 508 may include one or more output devices, such as, but not limited to, a display or printer.

The network devices 510 enable the computer system 500 to communicate with other networks or remote systems via one or more network(s) 518. Examples of the network devices 510 include, but are not limited to, a modem, a radio frequency (“RF”) or infrared (“IR”) transceiver, a telephonic interface, a bridge, a router, or a network card. The network 518 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 518 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

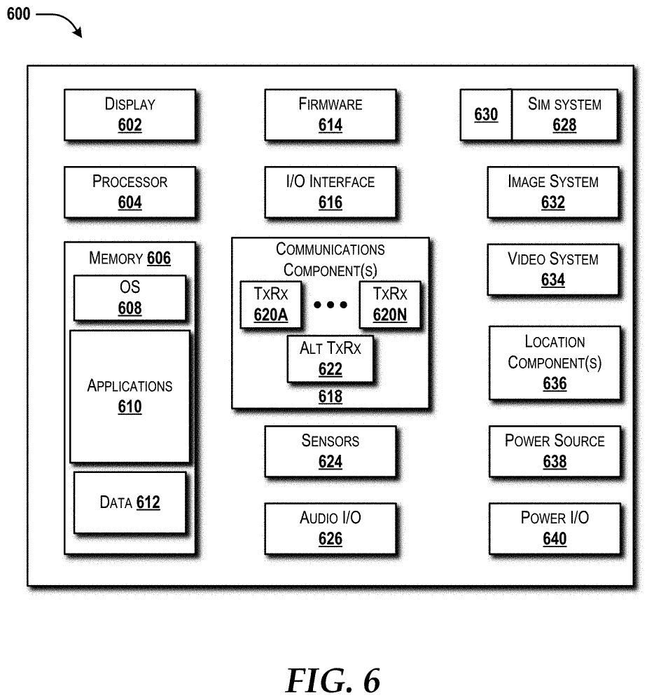

Turning now to FIG. 6, an illustrative mobile device 600 and components thereof will be described. In some embodiments, the user device 110 can be configured the same as or similar to the mobile device 600. In some embodiments, the user device 110 can be configured the same as or similar to the computer system 600. In some embodiments, the obfuscation and orchestration proxy system 114 can be configured the same as or similar to the computer system 600. In some embodiments, the disaggregated provider component(s) 112 can be configured the same as or similar to the computer system

While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. According to various embodiments, the display 602 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 600 can also include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in the memory 606, or the like. In some embodiments, the applications 610 can also include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE LLC, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering/deleting data, entering and setting user IDs and passwords for device access, configuring settings, manipulating content and/or settings, multimode interaction, interacting with other applications 610, and otherwise facilitating user interaction with the operating system 608, the applications 610, and/or other types or instances of data 612 that can be stored at the mobile device 600.

The applications 610, the data 612, and/or portions thereof can be stored in the memory 606 and/or in a firmware 614, and can be executed by the processor 604. The firmware 614 can also store code for execution during device power up and power down operations. It can be appreciated that the firmware 614 can be stored in a volatile or non-volatile data storage device including, but not limited to, the memory 606 and/or a portion thereof.

The mobile device 600 can also include an input/output (“I/O”) interface 616. The I/O interface 616 can be configured to support the input/output of data such as location information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 can also include a communications component 618. The communications component 618 can be configured to interface with the processor 604 to facilitate wired and/or wireless communications with one or more networks, such as the network 418, the Internet, or some combination thereof. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments, one or more of the transceivers of the communications component 618 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.6G, 3G, 4G, 4.5G, 5G, 6G and greater generation technology standards. Moreover, the communications component 618 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 618 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 618 can include a first transceiver (“TxRx”) 620A that can operate in a first communications mode (e.g., GSM). The communications component 618 can also include an N^{th} transceiver (“TxRx”) 620N that can operate in a second communications mode relative to the first transceiver 620A (e.g., UMTS). While two transceivers 620A-620N (hereinafter collectively and/or generically referred to as “transceivers 620”) are shown in FIG. 6, it should be appreciated that less than two, two, and/or more than two transceivers 620 can be included in the communications component 618.

The communications component 618 can also include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 618 can also facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 can also include one or more sensors 624. The sensors 624 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 can also include a subscriber identity module (“SIM”) system 628. The SIM system 628 can include a universal SIM (“USIM”), a universal integrated circuit card (“UICC”) and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Because other devices and/or modules for identifying users and/or the mobile device 600 are contemplated, it should be understood that these embodiments are illustrative, and should not be construed as being limiting in any way.

The mobile device 600 can also include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another device. The video and/or photo content can also be shared with other devices via various types of data transfers via wired and/or wireless communication devices as described herein.

The mobile device 600 can also include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 can also be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 can also include a power source 638. The power source 638 can include one or more batteries, power supplies, power cells, and/or other power subsystems including alternating current (“AC”) and/or direct current (“DC”) power devices. The power source 638 can also interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 600 or other devices or computers described herein, such as the computer system 500 described above with reference to FIG. 5. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 600 in order to store and execute the software components presented herein. It is also contemplated that the mobile device 600 may not include all of the components shown in FIG. 6, may include other components that are not explicitly shown in FIG. 6, or may utilize an architecture completely different than that shown in FIG. 6.

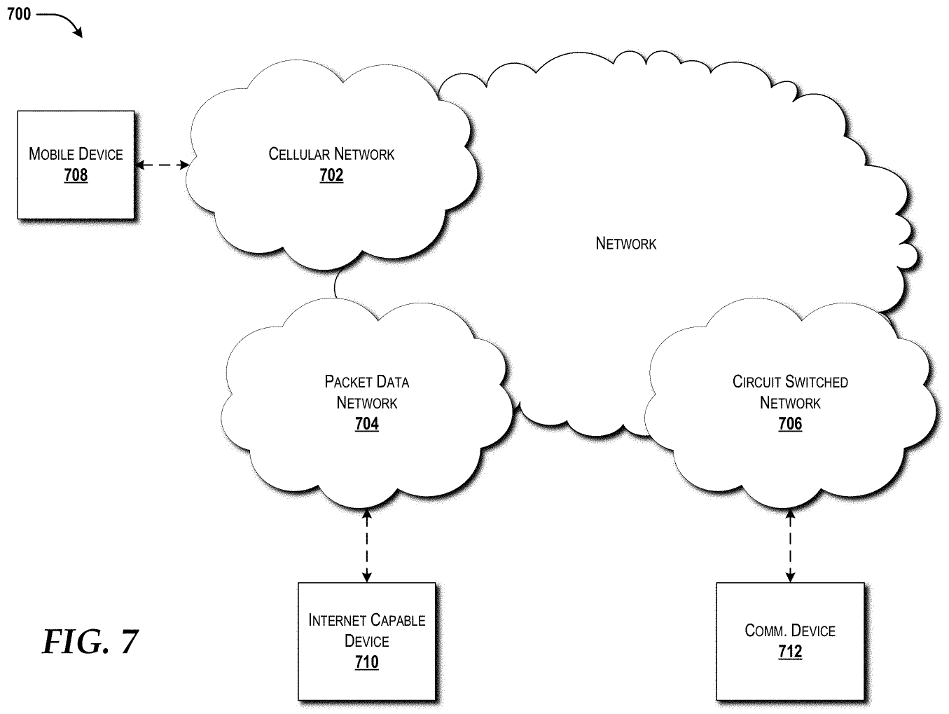

Turning now to FIG. 7, details of a network 700 are illustrated, according to an illustrative embodiment. The network 700 includes a cellular network 702, a packet data network 704, and a circuit switched network 706 (e.g., a public switched telephone network). The cellular network 702 includes various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the user device 110, a cellular telephone, a user equipment, a mobile terminal, a PDA, a laptop computer, a handheld computer, and combinations thereof, can be operatively connected to the cellular network 702. The mobile communications device 708 can be configured similar to or the same as the mobile device 600 described above with reference to FIG. 6.

The cellular network 702 can be configured as a GSM network and can provide data communications via GPRS and/or EDGE. Additionally, or alternatively, the cellular network 702 can be configured as a 3G Universal Mobile Telecommunications System (“UMTS”) network and can provide data communications via the HSPA protocol family, for example, HSDPA, EUL, and HSPA+. The cellular network 702 also is compatible with mobile communications standards such as LTE, or the like, as well as evolved and future mobile standards.

The packet data network 704 includes various systems, devices, servers, computers, databases, and other devices in communication with one another, as is generally known. In some embodiments, the user device 110, the obfuscation and orchestration proxy system 114, the disaggregated provider component(s) 112, or some combination thereof can communicate with each other via the packet data network 704. In some embodiments, the packet data network 704 is or includes one or more WI-FI networks, each of which can include one or more WI-FI access points, routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable systems/devices 710 such as the user device 110, the obfuscation and orchestration proxy system 114, the disaggregated provider component(s) 112, and/or other devices/systems can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

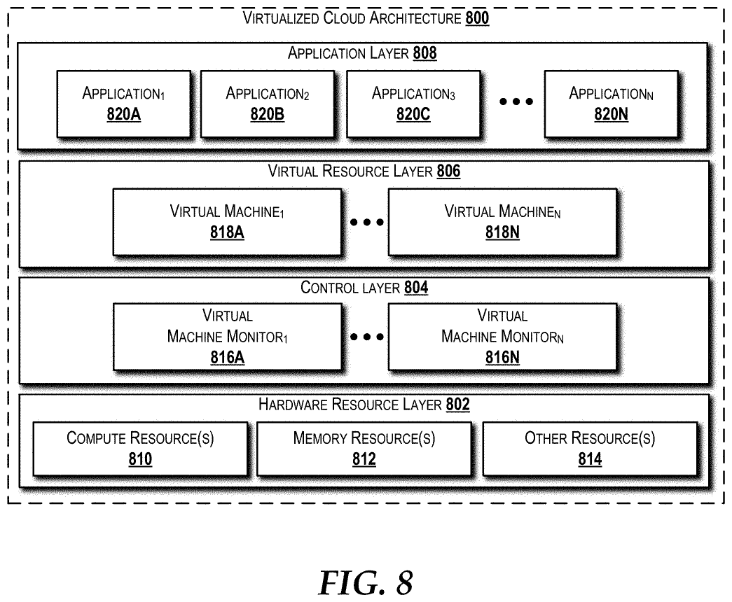

Turning now to FIG. 8, a block diagram illustrating an example virtualized cloud architecture 800 and components thereof will be described, according to an exemplary embodiment. In some embodiments, the virtualized cloud architecture 800 can be utilized to implement, at least in part, the obfuscation and orchestration proxy system 114, the disaggregated provider component(s) 112, or a portion thereof. The virtualized cloud architecture 800 is a shared infrastructure that can support multiple services and network applications. The illustrated virtualized cloud architecture 800 includes a hardware resource layer 802, a control layer 804, a virtual resource layer 806, and an application layer 808 that work together to perform operations as will be described in detail herein.

The hardware resource layer 802 provides hardware resources, which, in the illustrated embodiment, include one or more compute resources 810, one or more memory resources 812, and one or more other resources 814. The compute resource(s) 810 can include one or more hardware components that perform computations to process data, and/or to execute computer-executable instructions of one or more application programs, operating systems, and/or other software. The compute resources 810 can include one or more central processing units (“CPUs”) configured with one or more processing cores. The compute resources 810 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 810 can include one or more discrete GPUs. In some other embodiments, the compute resources 810 can include CPU and GPU components that are configured in accordance with a co-processing CPU/GPU computing model, wherein the sequential part of an application executes on the CPU and the computationally-intensive part is accelerated by the GPU. The compute resources 810 can include one or more system-on-chip (“SoC”) components along with one or more other components, including, for example, one or more of the memory resources 812, and/or one or more of the other resources 814. In some embodiments, the compute resources 810 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 810 can be or can include one or more hardware components architected in accordance with an advanced reduced instruction set computing (“RISC”) machine (“ARM”) architecture, available for license from ARM HOLDINGS. Alternatively, the compute resources 810 can be or can include one or more hardware components architected in accordance with an x86 architecture, such an architecture available from INTEL CORPORATION of Mountain View, California, and others. Those skilled in the art will appreciate the implementation of the compute resources 810 can utilize various computation architectures, and as such, the compute resources 810 should not be construed as being limited to any particular computation architecture or combination of computation architectures, including those explicitly disclosed herein.

The memory resource(s) 812 can include one or more hardware components that perform storage operations, including temporary or permanent storage operations. In some embodiments, the memory resource(s) 812 include volatile and/or non-volatile memory implemented in any method or technology for storage of information such as computer-readable instructions, data structures, program modules, or other data disclosed herein.

Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 810.

The other resource(s) 814 can include any other hardware resources that can be utilized by the compute resources(s) 810 and/or the memory resource(s) 812 to perform operations described herein. The other resource(s) 814 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 802 can be virtualized by one or more virtual machine monitors (“VMMs”) 816A-816N (also known as “hypervisors”; hereinafter “VMMs 816”) operating within the control layer 804 to manage one or more virtual resources that reside in the virtual resource layer 806. The VMMs 816 can be or can include software, firmware, and/or hardware that alone or in combination with other software, firmware, and/or hardware, manages one or more virtual resources operating within the virtual resource layer 806.

The virtual resources operating within the virtual resource layer 806 can include abstractions of at least a portion of the compute resources 810, the memory resources 812, the other resources 814, or any combination thereof. These abstractions are referred to herein as virtual machines (“VMs”). In the illustrated embodiment, the virtual resource layer 806 includes VMs 818A-818N (hereinafter “VMs 818”). Each of the VMs 818 can execute one or more applications 820A-820N in the application layer 808.

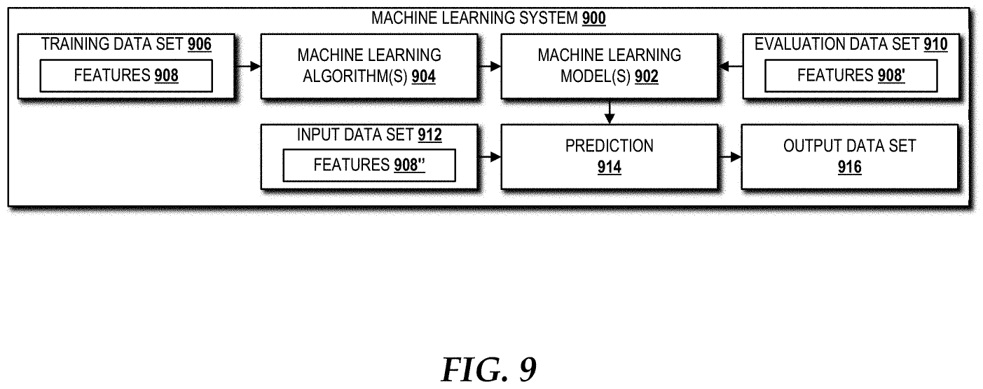

Turning now to FIG. 9, a machine learning system 900 capable of implementing aspects of the embodiments disclosed herein will be described. In some embodiments, the obfuscation and orchestration proxy system 114 can implement or otherwise utilize a machine learning system such as the machine learning system 900. For example, the machine learning system 900 can be used to determine and perfect one or more of the business flows 111. The illustrated machine learning system 900 includes one or more machine learning models 902. The machine learning models 902 can include supervised and/or semi-supervised learning models. The machine learning model(s) 902 can be created by the machine learning system 900 based upon one or more machine learning algorithms 904. The machine learning algorithm(s) 904 can be any existing, well-known algorithm, any proprietary algorithms, or any future machine learning algorithm. Some example machine learning algorithms 904 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 904 based upon the problem(s) to be solved by machine learning via the machine learning system 900.

The machine learning system 900 can control the creation of the machine learning models 902 via one or more training parameters. In some embodiments, the training parameters are selected modelers at the direction of an enterprise, for example. Alternatively, in some embodiments, the training parameters are automatically selected based upon data provided in one or more training data sets 906. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 904 converges to the optimal weights. The machine learning algorithm 904 can update the weights for every data example included in the training data set 906. The size of an update is controlled by the learning rate. A learning rate that is too high might prevent the machine learning algorithm 904 from converging to the optimal weights. A learning rate that is too low might result in the machine learning algorithm 904 requiring multiple training passes to converge to the optimal weights.

The model size is regulated by the number of input features (“features”) 906 in the training data set 906. A greater the number of features 908 yields a greater number of possible patterns that can be determined from the training data set 906. The model size should be selected to balance the resources (e.g., compute, memory, storage, etc.) needed for training and the predictive power of the resultant machine learning model 902.

The number of training passes indicates the number of training passes that the machine learning algorithm 904 makes over the training data set 906 during the training process. The number of training passes can be adjusted based, for example, on the size of the training data set 906, with larger training data sets being exposed to fewer training passes in consideration of time and/or resource utilization. The effectiveness of the resultant machine learning model 902 can be increased by multiple training passes.

Data shuffling is a training parameter designed to prevent the machine learning algorithm 904 from reaching false optimal weights due to the order in which data contained in the training data set 906 is processed. For example, data provided in rows and columns might be analyzed first row, second row, third row, etc., and thus an optimal weight might be obtained well before a full range of data has been considered. By data shuffling, the data contained in the training data set 906 can be analyzed more thoroughly and mitigate bias in the resultant machine learning model 902.

Regularization is a training parameter that helps to prevent the machine learning model 902 from memorizing training data from the training data set 906. In other words, the machine learning model 902 fits the training data set 906, but the predictive performance of the machine learning model 902 is not acceptable. Regularization helps the machine learning system 900 avoid this overfitting/memorization problem by adjusting extreme weight values of the features 908. For example, a feature that has a small weight value relative to the weight values of the other features in the training data set 906 can be adjusted to zero.

The machine learning system 900 can determine model accuracy after training by using one or more evaluation data sets 910 containing the same features 908′ as the features 908 in the training data set 906. This also prevents the machine learning model 902 from simply memorizing the data contained in the training data set 906. The number of evaluation passes made by the machine learning system 900 can be regulated by a target model accuracy that, when reached, ends the evaluation process and the machine learning model 902 is considered ready for deployment.

After deployment, the machine learning model 902 can perform a prediction operation (“prediction”) 914 with an input data set 912 having the same features 908″ as the features 908 in the training data set 906 and the features 908′ of the evaluation data set 910. The results of the prediction 914 are included in an output data set 916 consisting of predicted data. The machine learning model 902 can perform other operations, such as regression, classification, and others. As such, the example illustrated in FIG. 9 should not be construed as being limiting in any way.

Based on the foregoing, it should be appreciated that aspects of enhancing data privacy and owner capture of data value have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by an obfuscation and orchestration proxy system comprising a processor, a request for a service, wherein the request originates from a user, and wherein the user is associated with user data;
determining, by the obfuscation and orchestration proxy system, a business flow to be used to provide the service, wherein the business flow identifies a disaggregated provider component to provide, at least in part, the service; and
providing, by the obfuscation and orchestration proxy system, a portion of the user data to the disaggregated provider component.

2. The method of claim 1, further comprising revealing, by the obfuscation and orchestration proxy system, a further portion of the user data to the disaggregated provider component.

3. The method of claim 1, further comprising obfuscating the portion of the user data for data passthrough.

4. The method of claim 1, further comprising coordinating with the disaggregated provider component to provide a further portion of the user data using a temporary transaction-specific key.

5. The method of claim 1, wherein the service is an e-commerce service, the business flow is an e-commerce flow, and the disaggregated provider component comprises a catalog service component; wherein providing, by the obfuscation and orchestration proxy system, the portion of the user data to the disaggregated provider component comprises providing an obfuscated user identifier to the catalog service component; and wherein the method further comprises providing, by the obfuscation and orchestration proxy system, a search term identified in the request.

6. The method of claim 5, further comprising:
receiving, by the obfuscation and orchestration proxy system, from the catalog service component, a product identifier that identifies a product matching the search term;
providing, by the obfuscation and orchestration proxy system, the product identifier to a supplier;
receiving, by the obfuscation and orchestration proxy system, from the supplier, an offer and a supplier identifier associated with the supplier;
providing, by the obfuscation and orchestration proxy system, the offer and the supplier identifier to the user;
receiving, by the obfuscation and orchestration proxy system, from the user, an order specifying a payment method and a shipping destination;
providing, by the obfuscation and orchestration proxy system, the order to the supplier;
receiving, by the obfuscation and orchestration proxy system, a digital claim ticket for the order; and
providing, by the obfuscation and orchestration proxy system, the digital claim ticket to the user.

7. The method of claim 6, further comprising obfuscating, by the obfuscation and orchestration proxy system, the product identifier, the supplier identifier, the payment method, or the shipping destination.

8. A computer-readable storage medium comprising computer-executable instructions that, when executed by a processor of an obfuscation and orchestration proxy system, cause the processor to perform operations comprising:
receiving a request for a service, wherein the request originates from a user, and wherein the user is associated with user data;
determining a business flow to be used to provide the service, wherein the business flow identifies a disaggregated provider component to provide, at least in part, the service; and
providing a portion of the user data to the disaggregated provider component.

9. The computer-readable storage medium of claim 8, wherein the operations further comprise revealing a further portion of the user data to the disaggregated provider component.

10. The computer-readable storage medium of claim 8, wherein the operations further comprise obfuscating the portion of the user data for data passthrough.

11. The computer-readable storage medium of claim 8, wherein the operations further comprise coordinating with the disaggregated provider component to provide a further portion of the user data using a temporary transaction-specific key.

12. The computer-readable storage medium of claim 8, wherein the service is an e-commerce service, the business flow is an e-commerce flow, and the disaggregated provider component comprises a catalog service component; wherein providing the portion of the user data to the disaggregated provider component comprises providing an obfuscated user identifier to the catalog service component; and wherein the operations further comprise providing a search term identified in the request.

13. The computer-readable storage medium of claim 12, wherein the operations further comprise:
receiving, from the catalog service component, a product identifier that identifies a product matching the search term;
providing the product identifier to a supplier;
receiving, from the supplier, an offer and a supplier identifier associated with the supplier;
providing the offer and the supplier identifier to the user;
receiving, from the user, an order specifying a payment method and a shipping destination;
providing the order to the supplier;
receiving a digital claim ticket for the order; and
providing the digital claim ticket to the user.

14. The computer-readable storage medium of claim 13, wherein the operations further comprise obfuscating the product identifier, the supplier identifier, the payment method, or the shipping destination.

15. An obfuscation and orchestration proxy system comprising:
a processor; and
a memory comprising instructions that, when executed by the processor, cause the processor to perform operations comprising
receiving a request for a service, wherein the request originates from a user, and wherein the user is associated with user data,
determining a business flow to be used to provide the service, wherein the business flow identifies a disaggregated provider component to provide, at least in part, the service, and
providing a portion of the user data to the disaggregated provider component.

16. The obfuscation and orchestration proxy system of claim 15, wherein the operations further comprise revealing a further portion of the user data to the disaggregated provider component.

17. The obfuscation and orchestration proxy system of claim 15, wherein the operations further comprise obfuscating the portion of the user data for data passthrough.

18. The obfuscation and orchestration proxy system of claim 15, wherein the operations further comprise coordinating with the disaggregated provider component to provide a further portion of the user data using a temporary transaction-specific key.

19. The obfuscation and orchestration proxy system of claim 15, wherein the service is an e-commerce service, the business flow is an e-commerce flow, and the disaggregated provider component comprises a catalog service component; wherein providing the portion of the user data to the disaggregated provider component comprises providing an obfuscated user identifier to the catalog service component; and wherein the operations further comprise providing a search term identified in the request.

20. The obfuscation and orchestration proxy system of claim 19, wherein the operations further comprise:
receiving, from the catalog service component, a product identifier that identifies a product matching the search term;
providing the product identifier to a supplier;
receiving, from the supplier, an offer and a supplier identifier associated with the supplier;
providing the offer and the supplier identifier to the user;
receiving, from the user, an order specifying a payment method and a shipping destination;
providing the order to the supplier;
receiving a digital claim ticket for the order; and
providing the digital claim ticket to the user.
